(19) United States
(12) Patent Application Publication
(10) Pub. No.: US 2021/0073795 A1
(43) Pub. Date: Mar. 11, 2021

(54) DEVICE FOR STORING DIGITAL KEYS FOR SIGNING TRANSACTIONS ON A BLOCKCHAIN

(71) Applicant: COPSONIC, Montauban (FR)

(72) Inventors: Emmanuel RUIZ, Saint-nauphary (FR); Carlos David PILOTO FONSECA, Montauban (FR); Ruben ALFONSO REYES, Montbeton (FR); Brian ROETEN, Montbeton (FR)

(21) Appl. No.: 16/771,754

(22) PCT Filed: Dec. 12, 2018
(86) PCT No.: PCT/FR2018/053211

§ 371 Date: Nov. 2, 2020

(30) Foreign Application Priority Data
Dec. 14, 2017 (FR) 1762129

(51) Int. Cl. G06Q 20/36; H04L 9/06; H04L 9/08; H04L 9/30; H04L 9/32; H04B 11/00

(52) U.S. Cl. CPC G06Q 20/3674; H04L 9/0643; H04L 9/0897; H04L 9/0825; H04L 2209/38; H04L 9/3234; H04L 9/3215; H04B 11/00; G06Q 20/363; H04L 9/3066

(57) ABSTRACT

A physical device is designed to store digital keys for carrying out transactions on a blockchain. The physical device comprises a microphone, a loudspeaker, and a DSP processor comprising a secured element in which the pairs of secret keys and public keys are stored, the DSP also comprising an acoustic codec using a dictionary S containing words that represent random or pseudo-random ultrasonic signals stored in the memory of the DSP. The DSP is designed to decode a message consisting of words from S, received from an acoustic channel via the microphone, to sign the thus decoded message by a private key and to transmit the signature obtained in this way in the form of a response consisting of successive words from S, over the acoustic channel, via the loudspeaker.

### TECHNICAL FIELD

The present invention relates in general terms to blockchains and more particularly devices for storing cryptographic keys enabling a user to authenticate himself and to sign transactions on a blockchain.

### PRIOR ART

Blockchains, at the first rank of which are Bitcoin and Ethereum, have grown considerably in past years.

A blockchain is composed of a sequence of blocks concatenated by a cryptographic mechanism at regular time intervals. The concatenation is obtained by inserting the hash of the preceding block in the content of the current block. The blockchain forms a register that is distributed and replicated at all the nodes in the network.

The users can interact with the blockchain by means of lightweight clients for making, that is to say for forming and signing, transactions which, if they are validated, are stored in a block of the blockchain. One example of such a transaction is the transfer of a sum in cryptocurrency to a third party. These transactions are verified and then validated by a mechanism of consensus between nodes, referred to as miners, having a complete copy of the chain, and competing for constructing blocks according to the aforementioned cryptographic mechanism. Each validated transaction is stored in a block that is broadcast to all the nodes in the network.

Performing financial operations, and in general transactions, via a blockchain, requires having a wallet address on this chain (a Bitcoin address for example). Such an address is generally obtained by hashing the public key of a pair of asymmetric keys (private key-public key). More precisely, a user first generates a private key that he will have to keep confidential and deduces therefrom, by means of an encryption by an asymmetric cryptosystem, in this case an elliptic curve cryptosystem or ECC (Elliptic Curve Cryptography), the corresponding public key. This public key is next hashed by a hash function (Keccak, SHA-3 for example) in order to supply the wallet address in question.

Schematically, a wallet address on a blockchain can be considered to be a bank account number and the private key to be a password for validating access to this account.

In a blockchain such as Bitcoin, a transaction generally represents a transfer of a sum denominated in cryptocurrency (satoshis or bitcoins) from one or more wallet addresses of a sender to one or more wallet addresses of beneficiaries. More precisely, a transaction consumes one or more UTXOs (Unspent Transaction Output), each UTXO representing a sum not spent by its addressee and being locked at the wallet address of the latter by a locking script. In order to be able to spend a UTXO, the proprietor must identify himself by presenting to the UTXO cryptographic elements (generally his public key and a signature generated from the corresponding private key) in the form of an unlocking script. If the elements presented in the unlocking script satisfy the conditions specified in the locking script, the transaction is considered to be validated.

FIG. 1 illustrates schematically the example of a transfer of a sum in cryptocurrency between two users of a blockchain, Alice and Bob.

Alice makes a transaction from her wallet, the address of which, @walletAlice, is linked to a cryptographic public key (more precisely, @walletAlice is the hash of her public key).

It is supposed that the transaction consumes only one UTXO of Alice's wallet (of value fund), referred to as the input UTXO. The transaction creates a UTXO, referred to as the first output UTXO in Bob's wallet with the amount of the payment envisaged (of the value amount). Likewise, the transaction creates a second output UTXO in Alice's wallet with the balance (with the value balance=fund−amount).

In order to make the payment (with the value amount), Alice makes a transaction, Tₐ, composed of an input segment and an output segment.

The input segment of Tₐ (called scriptSig in Bitcoin) is a script responsible for unlocking the locking script (called scriptPubKey in Bitcoin) appearing in the output segment of the transaction, T_{fund}, that created the input UTXO.

The output segment of T_{c}, comprises:
a first locking script (scriptPubKey) that locks the value amount at Bob's wallet address, @walletBob, a lock that Bob will be able to unlock only by presenting an unlocking script (scriptSig) containing a signature authenticating him;
a second locking script (scriptPubKey) that locks the value balance, associated with Alice's wallet address, @walletAlice, a lock that Alice will be able to unlock only by presenting an unlocking script (scriptSig) containing a signature authenticating her.

The unlocking script, appearing in the input segment of Tₐ, is concatenated with the corresponding locking script, appearing in the output segment of T_{fund}, and the resulting script is executed.

Execution of the resulting script makes it possible to verify that the cryptographic elements supplied by Alice are indeed legitimate, that is to say the wallet address @walletAlice does indeed correspond to Alice's public key (verification by hashing) and that Alice is indeed the holder of this public key (verification by means of the signature). If the verification is positive, the transaction is validated and stored in a new block of the blockchain and this block is mined.

The validation and storage of the transaction de facto represents the creation of the first output UTXO to Bob's wallet and of the second output UTXO in Alice's wallet.

Bob will then be able in his turn to spend the sum amount using, as an input UTXO, the first output UTXO previously created. To do this, he will have to unlock by presenting his own cryptographic elements (public key and signature).

It will be understood that solely the holding of a private key makes it possible to make transactions on the blockchain using the corresponding wallet address. In other words, the private key constitutes the sole proof of ownership of the wallet and loss thereof will prevent any access to the cryptocurrency assets (UTXOs) held in this wallet. Likewise, if his secret key is stolen from him by a malevolent third party, the user is exposed to all his assets being spent by this third party.

Given the critical nature of the private key, it is generally recommended to store it generally in paper form rather than in electronic format in the memory of a smartphone or of a computer. Furthermore, the length of the private key makes it almost impossible for it to be memorised by the user himself and, even should he succeed in memorising it, it would be particularly tedious to provide it at each transaction.

Storage in paper form is scarcely compatible with roaming use. Furthermore, a user may possess a multiplicity of private keys and as many corresponding wallet addresses.

To remedy this problem, physical wallets (hardware wallets), essentially in the form of USB keys, in which a user can store his private keys as well as the corresponding public keys or the wallet addresses (obtained by hashing of the latter), have recently been marketed. Examples of such a hardware wallet are the devices sold under the name Trezor™ or “Ledger Nano S”.

These USB keys are generally provided with a simple interface (LCD screen and a few buttons) enabling the owner thereof to unlock it by means of a PIN code and to sign the transactions by means of the required private key. The secret keys are stored in a secure element, sheltered from physical attacks, which can be accessed only by means of the PIN code. These USB keys make it possible to store various keys and to sign transactions on a blockchain without having recourse to a paper medium. On the other hand, they are not completely immune against physical attacks since the private keys may be deduced from signals captured either by electromagnetic radiation or via the USB interface.

One object of the present invention is consequently to propose a device for storing digital keys enabling the owner thereof to authenticate himself and to sign transactions on a blockchain, under security conditions that are substantially increased compared with those of the prior art.

### DISCLOSURE OF THE INVENTION

The present invention is defined by a device for storing digital keys for signing transactions on a blockchain, said device comprising a microphone, a loudspeaker and a DSP processor having a secure element intended to store at least one secret key, the DSP further comprising an encoder/decoder using a codebook, S, the codewords of which, stored in a memory of the DSP or in a secure memory solely accessible to the DSP, represent random or pseudorandom ultrasound signals, the DSP communicating with the outside of the device only through an acoustic channel, the DSP being suitable for decoding a message consisting of words of S, received from an acoustic channel, via the microphone, for signing the message thus decoded by means of said private key and for transmitting in response a signature of said message in the form of a response consisting of successive words of S, on said acoustic channel, via the loudspeaker.

Advantageously, the device comprises a Human Machine Interface (HMI) by means of which the user can enter a private key or a seed for generating a succession of private keys, said private key or keys being stored in the secure element of the DSP processor.

The DSP processor typically uses an elliptic curve asymmetric cryptosystem for calculating a public key from the private key entered by the user or generated by the DSP from said seed.

Furthermore, the DSP processor is suitable for calculating a hash of said public key by means of a hash function in order to obtain a wallet address on a blockchain.

The device advantageously hosts a software module suitable for requesting of the DSP processor the transmission on the acoustic channel of the public key and/or of the wallet address on the acoustic channel.

According to a first example embodiment, the device is a smartphone, the DSP processor being implemented in a chip distinct from the microprocessor on which the operating system of the smartphone operates.

According to a second example embodiment, the device is a USB key not comprising any connection pins other than power supply pins.

The present invention further comprises a method for the payment, by a user, to a third party, of a sum in cryptocurrency by means of a digital-key storage device as defined above and a terminal hosting a second software module, said terminal being connected via the internet to the P2P network implementing the blockchain, characterised in that said user enters, in a window displayed by the second software module, the amount of the payment and the wallet address of the third party, and in that the second software module makes a transaction comprising an input segment and an output segment, the input segment comprising at least one reference to a prior transaction (T_{fund}) of which the user is the addressee, a script locking the prior transaction, the output segment comprising said sum and a script locking said sum at the wallet address of the third party, the second software module transmitting a first message (M) comprising the transaction thus formed to the digital-key storage device, and, in the event of validation by the user, the DSP processor signs said message and sends the signature thus obtained in the form of a second message (Sig) to said terminal, the first and second messages being transmitted over the acoustic channel in a form encoded by means of codewords of the codebook S, and the second software module replacing, in said transaction, the script locking the previous transaction with an unlocking script containing the signature thus received and the public key of the user.

Finally, the present invention relates to a method for the payment, by a user to a third party, of a sum in cryptocurrency by means of a digital-key storage device as defined above, implemented in the form of a computer or smartphone, the device hosting a second software module (225), and being connected via the internet to the P2P network implementing the blockchain, according to which said user enters, in a window displayed by the second software module, the amount of the payment and the wallet address of the third party, and in that the second software module makes a transaction comprising an input segment and an output segment, the input segment comprising at least one reference to a prior transaction (T_{fund}) of which the user is the addressee, a script locking the prior transaction, the output segment comprising said amount as well as a script locking said amount at the wallet address of the third party, the second software module transmitting a first message (M) comprising the transaction thus made to the digital-key storage device, and, in the event of validation by the user, the DSP processor signs said message and sends the signature thus obtained in the form of a second message (Sig) to the device, the first and second messages being transmitted over the acoustic channel in a form encoded by means of codewords of the codebook S, and the second software module replacing, in said transaction, the script locking the previous transaction with an unlocking script containing the signature thus received and the public key of the user.

After substitution, the transaction (Tₐ) is advantageously broadcast to the nodes of the P2P network in order to be validated and incorporated in a next block of the blockchain.

### BRIEF DESCRIPTION OF THE DRAWINGS

Other features and advantages of the invention will emerge from a reading of a preferential embodiment of the invention, made with reference to the accompanying figures, among which:

FIG. 1, already described, depicts schematically the transfer of a sum in cryptocurrency between two users of a blockchain;

FIG. 2 depicts schematically a system using a digital-key storage device according to one embodiment of the invention;

FIG. 3A depicts schematically a first example of architecture of the key-storage device of the system in FIG. 2;

FIG. 3B depicts schematically a first example of architecture of the key-storage device of the system in FIG. 2;

FIG. 4A depicts a timing diagram of an operation of consultation of a wallet by means of the system in FIG. 2;

FIG. 4B depicts a timing diagram of a payment operation by means of the system in FIG. 2;

FIG. 5A depicts schematically a digital-key storage device according to a first variant implementation of the invention;

FIG. 5B depicts schematically a digital-key storage device according to a second variant implementation of the invention.

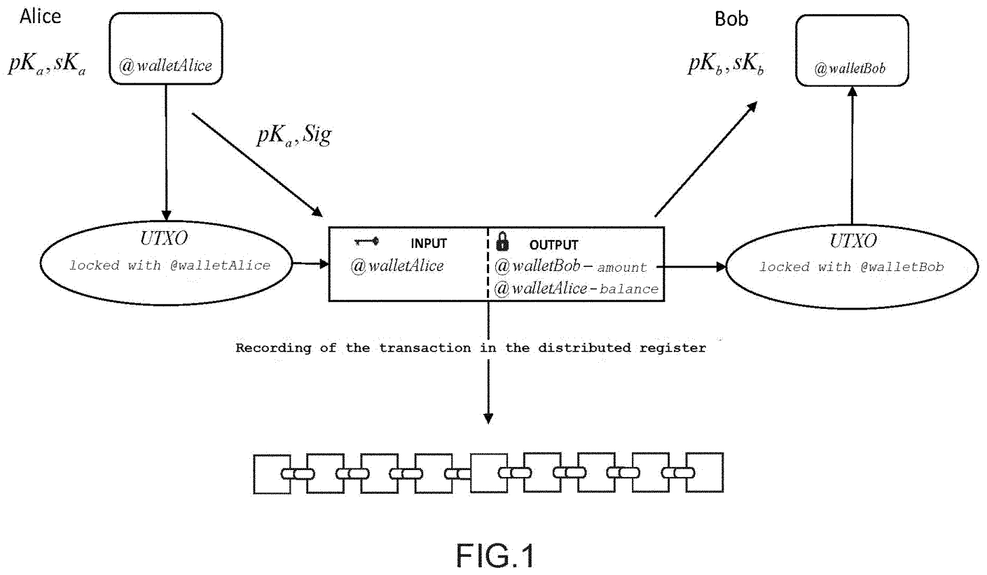

### DETAILED DISCLOSURE OF PARTICULAR EMBODIMENTS

The basic idea of the present invention is to provide a device (or physical wallet) for storing digital keys, comprising a loudspeaker, a microphone and a digital signal processor DSP with a secure element in which the pairs of secret keys and public keys are stored, the DSP communicating with the outside of the physical device only by means of random (or pseudorandom) ultrasound signals via said microphone and said loudspeaker.

To this end, the DSP comprises an acoustic coding/decoding module using a codebook S, the code words of which represent random or pseudorandom ultrasound signals stored in the memory of the DSP or in a secure memory of the device to which only the DSP has access. In other words, a code word is a digital representation of such a random or pseudorandom ultrasound signal, this signal being generated by converting the code word into an analogue signal, amplifying this analogue signal where necessary before driving a transducer.

The device is suitable for transmitting to and receiving from a wallet application cryptographic data, in the form of words of said codebook, via an acoustic channel between said device and the terminal hosting the wallet application.

Thus the cryptographic data are not transmitted via a USB or Bluetooth interface as in the prior art, with the inherent risks of interception (eavesdropping) or physical attacks. The use of short-range ultrasound signals makes these attempts at intrusion inoperative. Furthermore, transmitting cryptographic data by means of random or pseudorandom ultrasound signals substantially increases the robustness of the channel to such attacks.

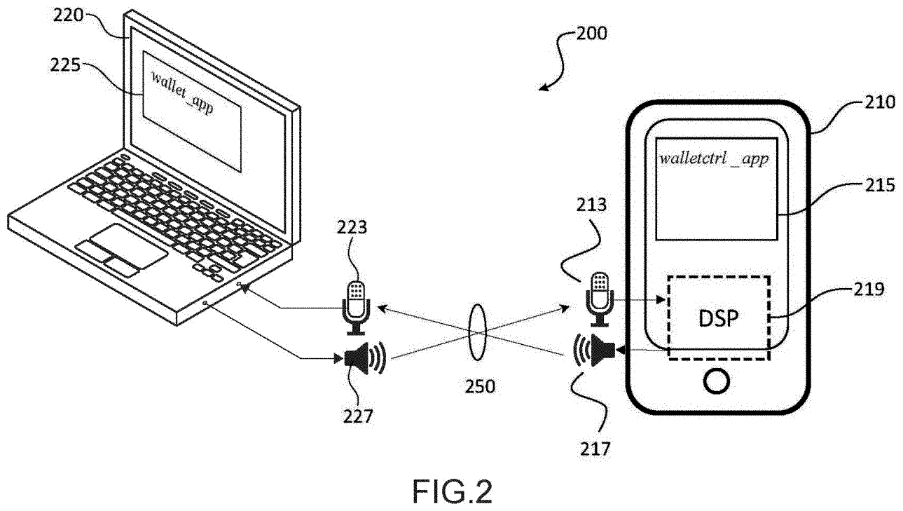

FIG. 2 depicts schematically a system comprising a digital-key storage device according to one embodiment of the invention.

The digital-key storage device (or physical wallet) has been depicted at 210 with the DSP at 219, the microphone at 213 and the loudspeaker at 217.

The device can be implemented in smartphone form as illustrated in the figure, or in the form of a dedicated USB key provided with a simple HMI interface (LCD screen and buttons for example), or even in the form of an authentication token (dedicated electronic box), or even also in the form of a portable computer. In this case, the DSP 219 can be the one already present by design in the portable computer.

It is important to note that, when the physical storage wallet is implemented in the form of a dedicated USB key, this comprises only power supply pins. Thus the key can be plugged into a USB connector of a computer and thus be powered without this computer being able to access the data stored in the physical wallet.

Apart from the physical wallet, the system 200 comprises a terminal (typically a portable computer, PC), 220, connected to the internet and consequently able to communicate with other nodes in the P2P (Peer to Peer) network using the blockchain.

In the remainder of the description, we shall suppose, without loss of generality, that the blockchain is Bitcoin.

The terminal of the user, 220, hosts a wallet application (wallet_app), 225, such as an SPV (Simplified Payment Verification) lightweight client conferring on the terminal the function of lightweight node and enabling it to make and check transactions on the blockchain. Alternatively, in the case of a non-roaming use, the terminal of the user can host a complete client, enabling it to have access to a copy of the whole of the shared register.

The wallet application 225 also comprises a decoding module using the codebook S enabling it to decode the random/pseudorandom signals received from the storage device. Alternatively, the terminal can comprise a DSP (not shown) performing such a decoding as requested by the application and returning to the latter the messages thus decoded. Alternatively again, the terminal can transmit the random/pseudorandom signals that it will have received to a decoding server in the cloud, which will then return to it the decoded messages. This last example embodiment is advantageous since it will be possible to switch the codebook S adaptively in the decoding server and the storage device.

The digital-key storage device 210 comprises a software module 215, referred to as a wallet control module (walletctrl_app), having the main function of generating one or more pairs (private, public key) and to sign messages by means of the private key thus generated, for example transactions made by the wallet application.

In a first phase, the physical digital-key storage wallet is initialised.

First of all, the physical wallet can be protected by means of a password (PIN code), a fingerprint reader, an iris sensor or any other biometric authentication sensor. The purpose of entering a password or biometric entry is simply to protect access to the physical wallet.

In the case where a password is used for authentication, this can be entered by means of the HMI interface (touchscreen for example) and validated for example by pressing a validation button or by clicking on a validation icon displayed on the screen.

Furthermore, the initialisation phase comprises the generation of at least one pair of keys (private key, public key) by an elliptic curve cryptosystem or ECC, the domain parameters of which were previously stored in the DSP. The private key can be obtained for example from a sequence of words entered or selected by means of the HMI interface. Preferably, this sequence is used as a seed for creating successive generations of pairs (private key—public key) of a hierarchical deterministic wallet (HD wallet), according to the standards BIP0032 and BIP044. In all cases, the private keys/public keys do not explicitly appear on the HMI interface but are generated within the DSP 219 and stored locally, the private keys being stored in the aforementioned secure element.

Once the initialisation phase has been implemented and the wallet application 225 launched on the terminal 220, it is possible to perform operations on the blockchain by means of the wallet in question.

The simplest operation is consulting the wallet, that is to say obtaining the list of UTXOs for which the user, or more precisely the address of his wallet, is the destination.

It will be recalled that the wallet address is obtained by a hashing of the public key of the user. The user can of course possess a plurality of public keys and a plurality of corresponding wallet addresses. In this case, the UTXOs at the destination of each of these addresses can be stored in a distinct directory in the wallet_app application.

If the physical wallet has stored only one (private key, public key) pair, the user can, via the HMI interface of the physical wallet, request the transmission of the public key, or even the address of the corresponding wallet, to the application 225.

If the physical wallet has stored in memory a plurality of public keys, the user can select, via the HMI interface, the required public key or wallet address and request transmission thereof to the application 225.

In both cases, the DSP transmits the public key/wallet address by means of random (or pseudorandom) ultrasound signals of the codebook S, on the acoustic channel 250. The codewords of S (random or pseudorandom ultrasound signals) are chosen so that the correlation metrics of these signals, optionally filtered by the equivalent filter of the acoustic channel, is as close as possible to a diagonal matrix. In other words, the random (or pseudorandom) ultrasound signals are chosen so that the values of the intercorrelation coefficients are minimum and those of the autocorrelation coefficients are maximum. The creation of such a codebook S is detailed in the French application number 16 55443 filed on 13 Jun. 2016, the content of which is incorporated here by reference.

These signals are sent by the loudspeaker (electroacoustic, for example piezoelectric, transducer) 217 of the physical device 210 and received by a microphone (for example a piezoelectric transducer) 223 of the terminal, in order to be supplied to the wallet application 225, either directly in the case where the wallet application is responsible for the decoding, or after decoding by the DSP resident in the terminal, or by decoding by means of a decoding server as indicated above.

Whatever the decoding variant, the wallet application can then lodge a request on the blockchain in order to seek the transactions (for example by means of a blockchain browser such as block explorer or an API such as blockchain.info) for this address. If the public key is transmitted to the terminal, the wallet application can determine the corresponding wallet address by simple hashing and launch the request as before. The chain is then scanned in order to seek the transactions intended for this address. In all cases, the transactions for which Alice is the destination are displayed in a window of the application 225.

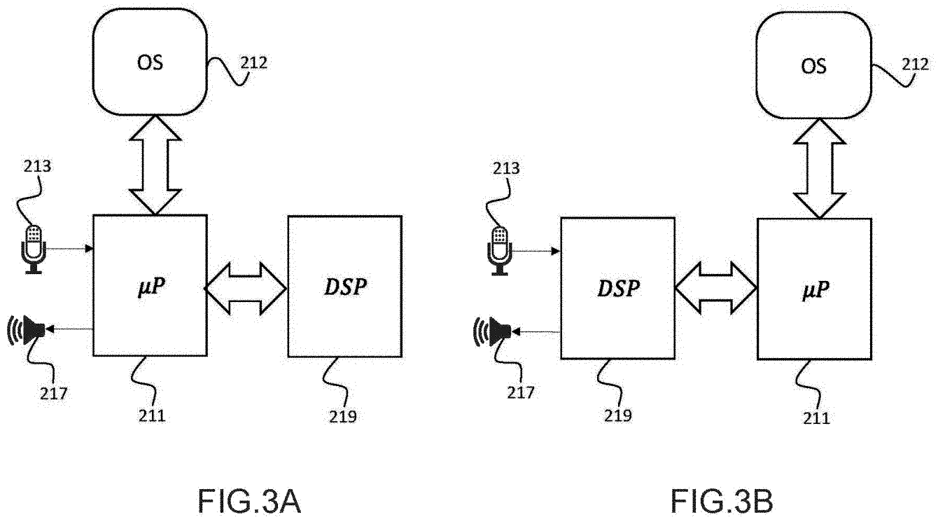

FIG. 3A depicts a first example of architecture of the digital-key storage device in the system of FIG. 2.

The operating system 212 (for example Android™) runs on the microprocessor 211. The operating system preferably communicates to the DSP only through the microprocessor so as to reinforce the robustness to attacks.

The microprocessor receives from the DSP digital messages in the form of words from the codebook S and transfers them to the driver of the loudspeaker 217. These messages are converted to analogue and amplified and the resulting signals are transformed into corresponding ultrasound signals by the loudspeaker 217, in order to be transmitted over the acoustic channel 250.

Reciprocally, the microprocessor receives from the microphone 213 ultrasound signals, previously converted in digital form, and transmits them to the DSP 219.

It will be understood here that the microprocessor plays a transparent role in the exchanges between the DSP and the outside of the device.

FIG. 3B depicts a second example of architecture of the digital-key storage device in the system of FIG. 2.

The DSP can receive control messages and, where applicable, return response messages to the microprocessor as before. On the other hand, in this example, the DSP directly receives and transmits the random/pseudorandom ultrasound signals without passing through the microprocessor. In a particular example embodiment, the DSP, the loudspeaker and the microphone form part of one and the same sound card.

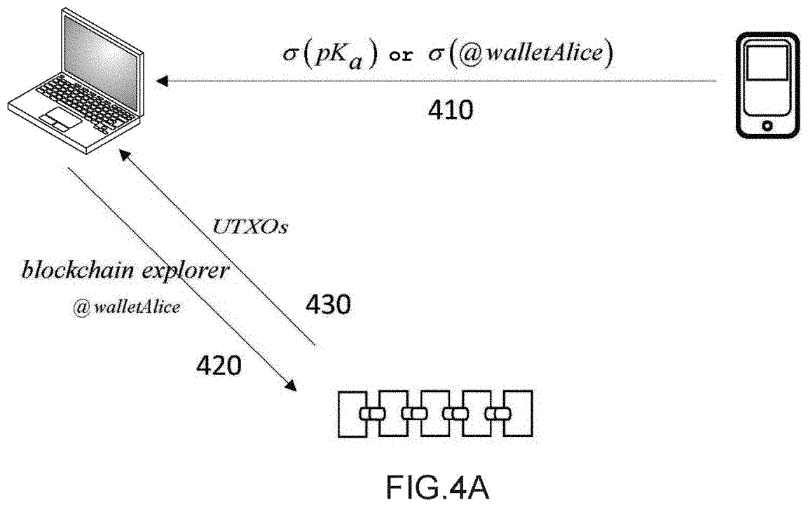

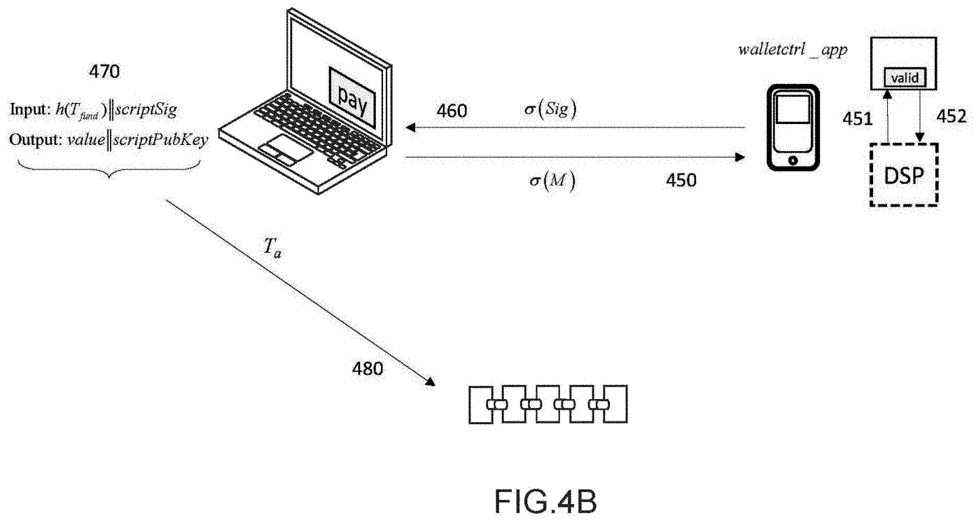

FIG. 4A schematically recapitulates the exchanges in the system 200 when Alice consults her wallet. In 410, the physical wallet transmits Alice's public key pKₐ or the wallet address @walktAlice, via the acoustic channel, to the application wallet_app of the terminal.

More precisely, the public key pKₐ is transmitted in the form of a random/pseudorandom ultrasound signal σ(pKₐ) where σ designates the operation of coding by means of the aforementioned codebook S. Alternatively, the wallet address @walletAlice will be transmitted in the form of a random/pseudorandom ultrasound signal σ(@walletAlice).

After decoding of this signal, the application transmits a request at 420 to scan in the blockchain the transactions for which @walletAlice is the destination. After having recovered these transactions at 430, Alice can list the UTXOs at her address (transactions for which @walletAlice is the destination the output of which is not spent) in order to aggregate them if necessary.

The UTXO, or even the aggregated UTXOs in the case of an aggregation, can thus be used as inputs of a new transaction in order to make a payment.

Conversely, the address @walletAlice can be communicated in coded form σ(@walletAlice) via an acoustic channel to a third party having a terminal 220 such as the one previously described, so that he can make a payment to Alice's wallet address.

Thus, if Alice wishes to make a payment to Bob, she opens her wallet application 225 on the terminal 220 and fulfils the parameters necessary for the transaction.

She selects in her portfolio the UTXO (or even the UTXOs in the case of aggregation) that she wishes to use for the transfer, the amount to be transferred and the wallet address of the beneficiary, @walletBob. Without loss of generality, it is supposed hereinafter that only one UTXO is selected. This UTXO is the output of a source transaction T_{fund}, in other words the transaction T_{fund} has created this UTXO.

The wallet application then makes a new transaction Tₐ, for example by means of a P2PKH (Pay to Public Key Hash) script.

In the input segment of Tₐ, the application first of all supplies the reference of the UTXO selected, that is to say the hash of the source transaction T_{fund}, that is to say h(T_{fund}).

In the output segment of Tₐ, the application next supplies the amount to transfer and a locking script locking this amount at the wallet address @walletBob.

The application 225 must next supply the cryptographic elements for unlocking the locking script that protects the input UTXO of Tₐ (UTXO for @walletAlice in the source transaction T_{fund}), namely its public key and a signature by means of its private key.

To do this, the wallet software 225 requests the physical wallet 210 to sign the transaction by sending to it a message M, comprising the hash of the source function h(T_{fund}), the locking script (scriptPubKey) of the source transaction T_{fund}, the amount in cryptocurrency and the locking script (scriptPubKey) locking said amount at the wallet address @walletBob.

The message M is transmitted to the DSP via the acoustic channel, in the form σ(M) obtained by a coding M by means of the codebook S. The corresponding ultrasound signals are sent by the loudspeaker 227 of the terminal and received by the microphone 213 of the physical wallet 210.

The DSP transmits, via the microprocessor to the application walletctrl_app the address of the destination of the payment as well as the amount. The application then requests the user to confirm the transaction (by pressing on an icon of the touchscreen or button). If the user confirms it before the expiry of a time_out, the application walletctrl_app advises the DSP of this, which then signs the message M with the private key (by means of an elliptic curve signature algorithm or ECDSA) and transmits the signature obtained, Sig, to the terminal 220. The signature Sig is transmitted in a coded form, σ(Sig), by means of the signals from the codebook S, via the acoustic channel.

There again, the signal σ(Si_{g}) can be decoded by the wallet application, the local DSP or a remote decoding server. After decoding, the wallet application 225 recovers the signature Sig and concatenates it with Alice's public key pKₐ in order to form the unlocking script (scriptSig). The application wallet_app supplies the hash of the source transaction h(T_{fund}) and the unlocking script to form the input segment of the transaction Tda.

The wallet application then invites the user to confirm the payment (for example by clicking on an icon). If the payment is confirmed, the transaction Tₐ is broadcast to the nodes in the P2P network in order to be validated and incorporated in a future block of the chain.

FIG. 4B schematically recapitulates the exchanges in the system 200 when Alice makes a payment.

At step 450, after the user has entered the amount of the payment and the wallet address of the beneficiary in a window of the wallet application, the latter constructs a message M from the hash of the source transaction h(T_{fund}), from the locking script of the source transaction, from the amount of the payment in cryptocurrency, and from a locking script locking the amount at the wallet address of the beneficiary, @walletBob.

The signal σ(M) obtained by coding M (by means of the codebook S) is transmitted over the acoustic channel by means of the random ultrasound signals from the codebook S.

After decoding of σ(M) and recovery of the message M by the DSP, the latter transmits at 451 the wallet address of the beneficiary and the amount to the control application walletctrl_app.

The validation by the user is transmitted by walletctrl_app to the DSP at 452. The DSP then signs the message M by means of its private key (EDCSA), encodes the signature obtained with the codebook S in order to obtain a signal σ(Sig) and transmits the latter to the terminal 220, as before, via the acoustic channel.

The signal σ(S/g) is decoded at the terminal 220 in order to provide the signature Sig.

The wallet application wallet_app then at 370 constructs the unlocking script from the signature thus received and from Alice's public key in order to form the input segment of the transaction. Likewise, it concatenates the locking script with the amount in order to form the output segment of the transaction.

Once the payment has been validated by the user on the window of the wallet application, the latter broadcasts it at 480 to the other nodes in the P2P network.

In the above description, we have supposed that the blockchain was Bitcoin. Alternatively, it may be a blockchain in which it is possible to record and execute smart contracts. One example of such a blockchain is Ethereum. A smart contract is a program that can be executed by any node in the P2P network using the blockchain. It may in particular store data, send and receive payments, and execute actions autonomously and in a decentralised fashion as a software agent. Generally, a smart contract checks whether a certain number of conditions are fulfilled and, if so, is executed automatically in order to supply a result encoded in the contract.

The physical wallet of the digital keys makes it possible in the same way to authenticate itself as part of a smart contract and, for example, to give its consent. To do this, the wallet application (or account application according to Ethereum terminology) can make a transaction and the owner can sign it by means of the physical wallet, the transaction thus signed being transmitted to the smart contract stored in the blockchain.

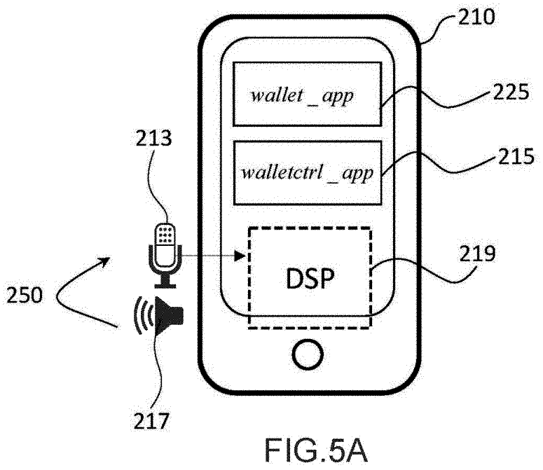

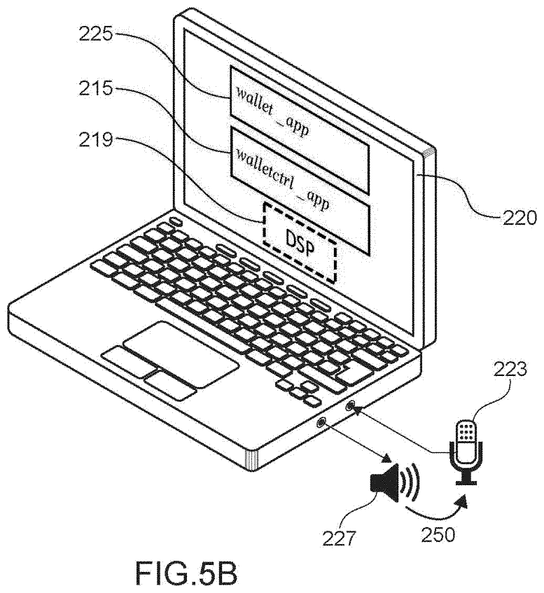

Finally, in the above description it has been supposed that the terminal 220 was distinct from the digital-key storage device 210. If the latter is a smartphone, it can also serve as a terminal connected to the internet: the terminal is then coincident with the device and the first and second software modules are modules of one and the same application (or even distinct applications of the smartphone as depicted in the example embodiment in FIG. 5A. They then dialogue via a local acoustic channel between the loudspeaker 217 and the microphone 213.

Conversely, the terminal may incorporate the DSP 219 with its secure element, the first and second software modules forming part of one and the same application (or even distinct applications) of the terminal, as depicted in the example embodiment in FIG. 5B. These software modules then dialogue via a local acoustic channel between the loudspeaker 217 and the microphone 213, as in the first example implementation.

We have also supposed in the description that the key-storage device/the terminal had available the same codebook S for sending and receiving messages. Alternatively, it is possible to use two distinct codebooks S and S′ for sending and receiving, the sending codebook of one being the reception codebook of the other and vice versa. This embodiment is advantageous since it allows a full duplex exchange on the acoustic channel.

What is claimed is:

1. Device for storing digital keys for signing transactions on a blockchain, the device comprising a microphone (213), a loudspeaker (217) and a DSP processor (219) having a secure element intended to store at least one secret key, the DSP further comprising an encoder/decoder using a codebook, S, the codewords of which, stored in a memory of the DSP or in a secure memory solely accessible to the DSP, represent random or pseudorandom ultrasound signals, the DSP communicating with the outside of the device only through an acoustic channel (250), the DSP being suitable for decoding a message consisting of words of S, received from an acoustic channel, via the microphone (213), for signing the message thus decoded by means of said private key and for transmitting in response a signature of said message in the form of a response consisting of successive words of S, on said acoustic channel, via the loudspeaker (217).

2. Digital-key storage device according to claim 1, further comprising a Human Machine interface by means of which the user can enter a private key or a seed for generating a succession of private keys, said private key or keys being stored in the secure element of the DSP processor.

3. Digital-key storage device according to claim 2, wherein the DSP processor typically uses an elliptic curve asymmetric cryptosystem for calculating a public key from the private key entered by the user or generated by the DSP from said seed.

4. Digital-key storage device according to claim 3, wherein the DSP processor is suitable for calculating a hash of said public key by means of a hash function in order to obtain a wallet address on a blockchain.

5. Digital-key storage device according to claim 4, wherein the device hosts a software module (215) suitable for requesting of the DSP processor the transmission on the acoustic channel of the public key and/or of the wallet address on the acoustic channel.

6. Digital-key storage device according to claim 1, wherein the device is implemented in the form of a smartphone, the DSP processor being implemented in a chip distinct from the microprocessor on which the operating system of the smartphone operates.

7. Digital-key storage device according to claim 1, wherein the device is implemented in the form of a USB key not comprising any connection pins other than power supply pins.

8. Method for the payment, by a user, to a third party, of a sum in cryptocurrency by means of a digital-key storage device according to claim 1 and a terminal (220) hosting a second software module (225), said terminal being connected via the internet to the P2P network implementing the blockchain, wherein said user enters, in a window displayed by the second software module, the amount of the payment and the wallet address of the third party, and in that the second software module makes a transaction comprising an input segment and an output segment, the input segment comprising at least one reference to a prior transaction (T_{fund}) of which the user is the addressee, a script locking the prior transaction, the output segment comprising said sum and a script locking said sum at the wallet address of the third party, the second software module transmitting (450) a first message (M) comprising the transaction thus formed to the digital-key storage device, and, in the event of validation by the user (452), the DSP processor signs said message and sends (460) the signature thus obtained in the form of a second message (Sig) to said terminal, the first and second messages being transmitted over the acoustic channel in a form encoded by means of codewords of the codebook S, and the second software module replacing, in said transaction, the script locking the previous transaction, with an unlocking script containing the signature thus received and the public key of the user.

9. Method for the payment, by a user to a third party, of a sum in cryptocurrency by means of a digital-key storage device according to claim 1, implemented in the form of a computer or smartphone, the device hosting a second software module (225), and being connected via the internet to the P2P network implementing the blockchain, wherein said user enters, in a window displayed by the second software module, the amount of the payment and the wallet address of the third party, and in that the second software module makes a transaction comprising an input segment and an output segment, the input segment comprising at least one reference to a prior transaction (T_{fund}) of which the user is the addressee, a script locking the prior transaction, the output segment comprising said amount as well as a script locking said amount at the wallet address of the third party, the second software module transmitting (450) a first message (M) comprising the transaction thus made to the digital-key storage device, and, in the event of validation by the user (452), the DSP processor signs said message and sends (560) the signature thus obtained in the form of a second message (Sig) to the device, the first and second messages being transmitted over the acoustic channel (250) in a form encoded by means of codewords of the codebook S, and the second software module replacing, in said transaction, the script locking the previous transaction with an unlocking script containing the signature thus received and the public key of the user.

10. Payment method according to claim 8, wherein, after substitution, the transaction (Tₐ) is broadcast (480) to the nodes of the P2P network in order to be validated and incorporated in a next block of the blockchain.
